(19) United States
(12) Patent Application Publication
(10) Pub. No.: US 2006/0220334 A1
(43) Pub. Date: Oct. 5, 2006

(54) Article carrying cart

(76) Inventor: Li Wen Liao, Alhambra, CA (US)

Correspondence Address: Li Wen Liao, 928 N. Marguerita Ave., Alhambra, CA, 91801, US

(21) Appl. No.: 11/091,690

(22) Filed: Mar. 29, 2005

(51) Int. Cl. B62B 3/00

(52) U.S. Cl. 280/47.34; 280/655.1

(57) ABSTRACT

An article carrying cart includes a platform having a wheel device rotatably attached to a bottom portion with a wheel axle, a handle device pivotally attached to the platform, and a latching device for latching the handle device on the platform at an upwardly extending and working position. One or more step motors may be attached to the platform and coupled to the wheel device, for actuating the wheel device to move the platform. The handle device includes an actuator button for operating the step motors to control the article carrying cart. A latch may selectively latch and lock the barrel and the handle device to the platform at the upwardly extending and working position.

### BACKGROUND OF THE INVENTION

1. Field of the Invention

The present invention relates to an article carrying cart, and more particularly to an article carrying cart changeable to various kinds of structures, for carrying the users, the luggage articles, or other articles.

2. Description of the Prior Art

Typical article carrying carts comprise a base including one or more wheels rotatably attached thereto, for allowing the base to be moved elsewhere, and a handle device, such as a retractable handle device attached to or extended from the base, for adjustably moving or operating the typical article carrying carts.

For example, U.S. Pat. No. 4,896,897 to Wilhelm discloses one of the typical article carrying carts, including a main frame that is provided with a pair of wheels and a lower load carrying platform shiftable between a load carrying position and a stowed position. However, the typical article carrying carts may be used for carrying the luggage articles, or other articles, but may not be used to carry or to support the users thereon.

U.S. Pat. No. 6,561,294 to Kamen et al. discloses another typical article carrying cart or balancing vehicle including a support, such as a seat to support the users thereon, and arranged in a manner as to allow the position of the center of gravity of the vehicle to be varied by motion of the support. Motion of the support additionally provides for control of a drive that propels the vehicle in a manner responsive to the position of the center of gravity. The vehicle is thus capable of control by leaning of a seated rider.

However, the typical balancing vehicle may be used for supporting the users thereon, and arranged for being moved by the riders supported thereon, but may not be used to carry or to support the luggage articles, or other articles thereon.

The present invention has arisen to mitigate and/or obviate the afore-described disadvantages of the conventional article carrying carts.

### SUMMARY OF THE INVENTION

The primary objective of the present invention is to provide an article carrying cart changeable to various kinds of structures, for carrying the users, the luggage articles, or other articles.

In accordance with one aspect of the invention, there is provided a article carrying cart comprising a platform including a wheel device rotatably attached to a bottom portion thereof with a wheel axle, to allow the platform to be moved with the wheels, a handle device pivotally attached to the platform, a latching device for latching the handle device on the platform at an upwardly extending and working position, and an actuating device for actuating the wheel device to move the platform.

The actuating device includes at least one step motor attached to the bottom portion of the platform, and coupled to the wheel axle of the wheel device, to rotate the wheel device. The platform includes at least one battery attached to the bottom portion thereof and coupled to the step motor, to energize the step motor. The handle device includes an actuator button disposed thereon, for operating the step motor to control the article carrying cart.

The platform includes a front portion having an opening formed therein, a barrel received in the opening of the platform and rotatably secured to the platform with a shaft, the handle device is secured to the barrel. The platform includes a cavity formed therein, the barrel includes an aperture formed therein for selectively aligning with the cavity of the platform, the latching device includes a latch slidably received in the barrel and engaged through the aperture of the barrel, for selectively engaging through the cavity of the platform, to selectively latch and lock the barrel and the handle device to the platform at the upwardly extending and working position.

The barrel includes a block received therein and having a channel formed therein to slidably receive the latch. The latch includes a slot formed therein, a follower is slidably received in the slot of the latch and includes an inclined groove formed therein, a pin is engaged into the latch and engaged through the slot of the latch and engaged through the inclined groove of the follower, to force the latch in and out relative to the barrel when the follower is moved up and down relative to the barrel and the platform.

The barrel includes a spring member disposed therein and engaged with the follower, for biasing the follower upwardly away from the block, and to force the latch to engage into the cavity of the platform. The handle device includes a tube secured to the barrel, and at least one extension slidably engaged in the tube, and extendible out of the tube, the follower includes an enlarged head provided thereon and slidably engaged in the tube, for limiting the follower to slide up and down relative to the tube, and for preventing the follower from moving sidewise or laterally relative to the tube.

The handle device includes a hand grip provided thereon for supporting an upper portion of a user. The handle device includes a knob slidably engaged therein, and a rod secured to the knob and moved in concert with the knob, and slidably engaged into the extension and the tube of the handle device, the rod includes a lower actuator secured thereto, for actuating the follower to move the latch in and out relative to the barrel.

The platform includes a rear portion having a flap pivotally thereto with a pivot joint, and arranged to be rotated relative to the platform between a downwardly folding position and an upwardly extended working position to selectively anchor articles on the platform. The platform includes a depression formed in an upper portion thereof to selectively receive the flap in the downwardly folding position. The flap includes a seat post selectively attached and secured thereon, and a seat cushion attached onto the seat post, to support a user thereon.

The platform includes a front portion having at least one foot pedal pivotally attached thereto with a pivot pole, and includes a stud extended from the foot pedal, and a spring-biased catch engaged in the stud, to engage with the platform, and to anchor the foot pedal to the platform at a selected position. The platform includes a depression formed therein to selectively receive the foot pedal therein. The platform includes a notch formed therein and communicating with the depression thereof, to rotatably receiving the stud of the foot pedal.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an article carrying cart in accordance with the present invention;

FIG. 2 is a perspective view as seen from the rear portion of the article carrying cart;

FIG. 3 is a perspective view as seen from the front portion of the article carrying cart;

FIG. 4 is a partial cross sectional view of the article carrying cart, taken along lines 4-4 of FIG. 2;

FIG. 5 is a partial cross sectional view similar to FIG. 4, illustrating the operation of the article carrying cart;

FIG. 6 is a perspective view illustrating the operation of the article carrying cart;

FIG. 7 is a perspective view similar to FIG. 6, illustrating the other operation of the article carrying cart;

FIG. 8 is a front view of the article carrying cart as shown in FIG. 7;

FIG. 9 is a perspective view similar to FIGS. 6 and 7, illustrating the other application of the article carrying cart;

FIG. 10 is a partial cross sectional view taken along lines 10-10 of FIG. 9;

FIG. 11 is a perspective view similar to FIGS. 6, 7 and 9, illustrating the further application of the article carrying cart;

FIG. 12 is a perspective view similar to FIGS. 6, 7, 9 and 11, illustrating the folding operation of the article carrying cart;

FIG. 13 is a perspective view similar to FIGS. 6, 7 and 9, illustrating the still further application of the article carrying cart;

FIG. 14 is a partial cross sectional view taken along lines 14-14 of FIG. 12; and

FIG. 15 is another partial cross sectional view of the article carrying cart as shown in FIG. 13.

### DETAILED DESCRIPTION OF THE PREFERRED EMBODIMENT

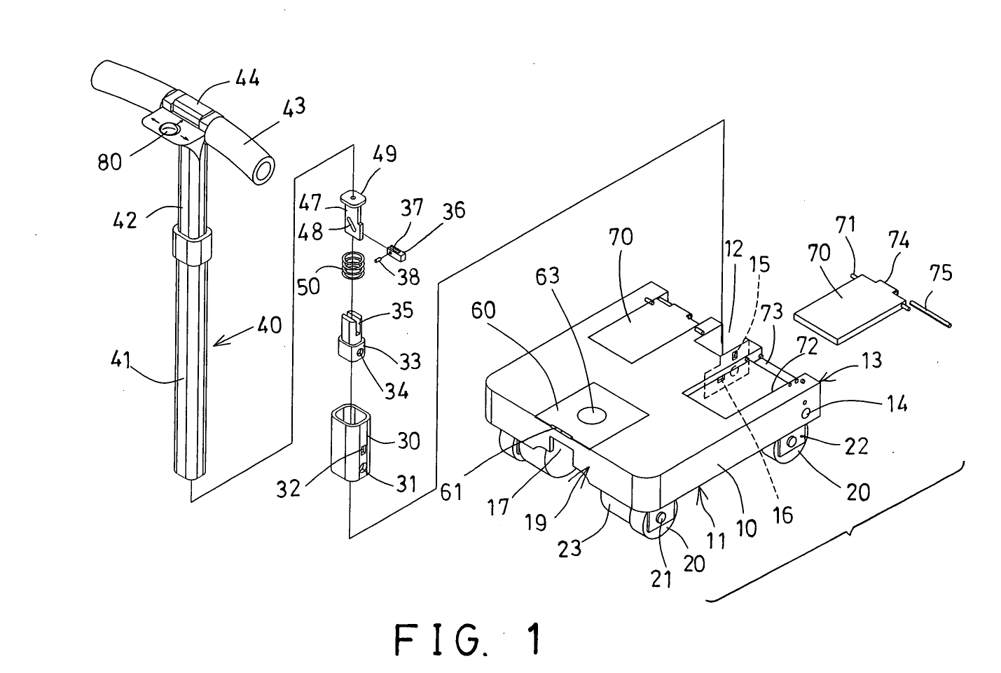

Referring to the drawings, and initially to FIGS. 1-4, an article carrying cart in accordance with the present invention comprises a base platform 10 including a wheel device 20 having one or more, such as two pairs of wheels 20 rotatably attached to a bottom portion 11 thereof with wheel axles 21, to allow the platform 10 to be moved elsewhere. For example, the platform 10 includes one or more, such as two pairs of brackets 22 attached to or extended from the bottom portion 11 of the platform 10, to rotatably attach the wheels 20 with the wheel axles 21 respectively.

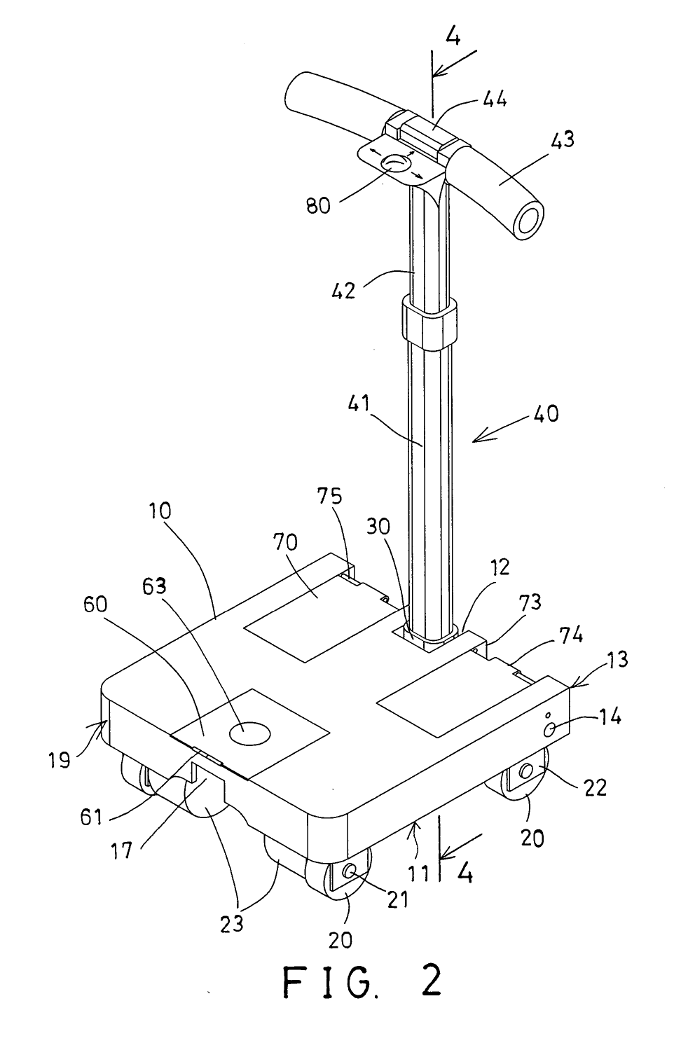

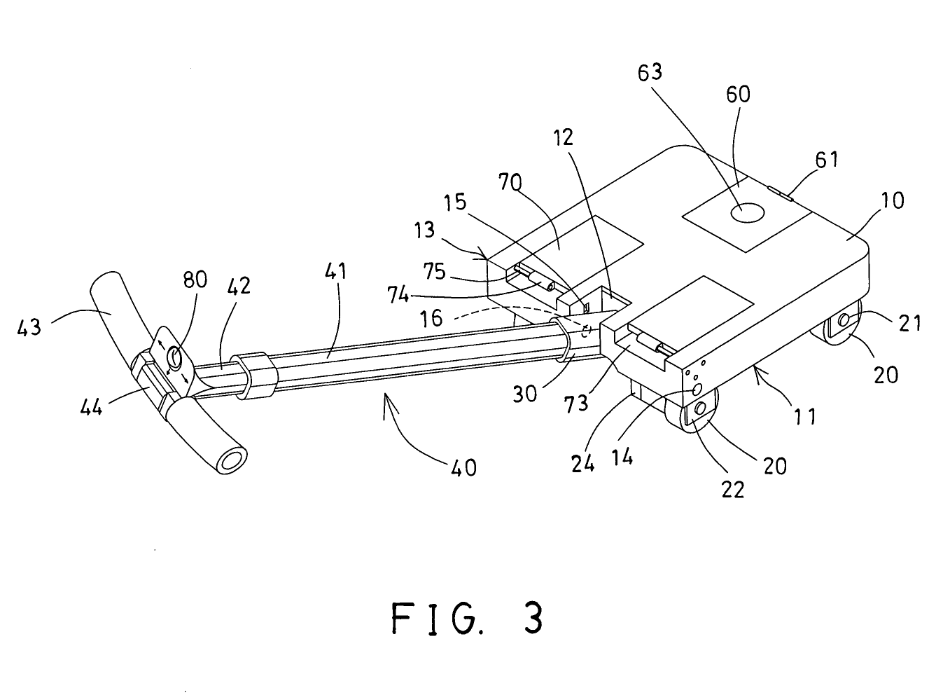

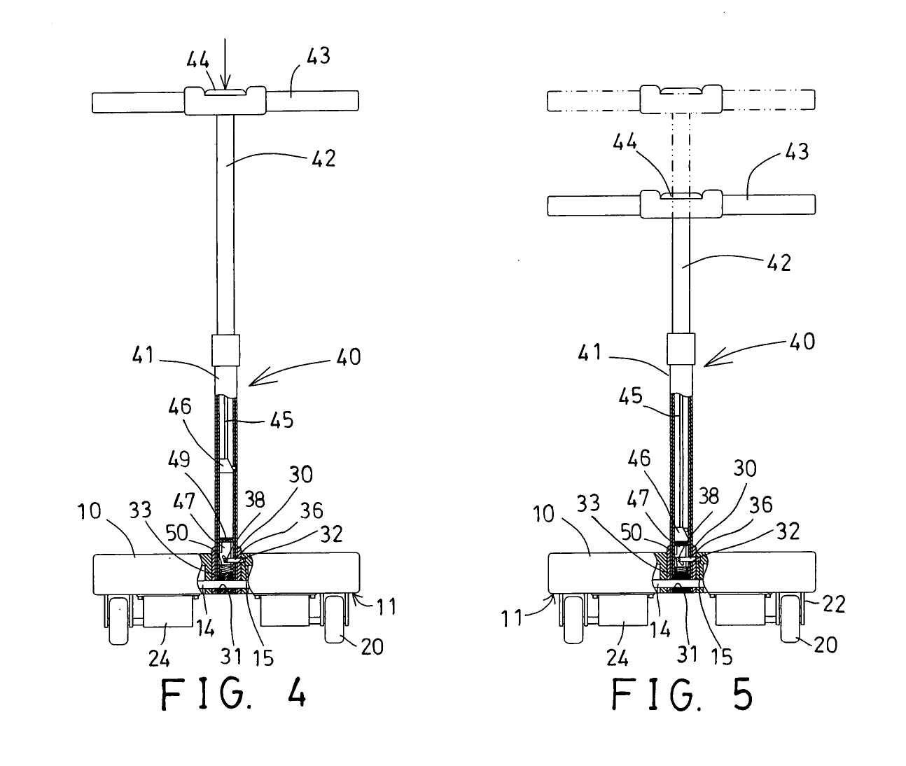

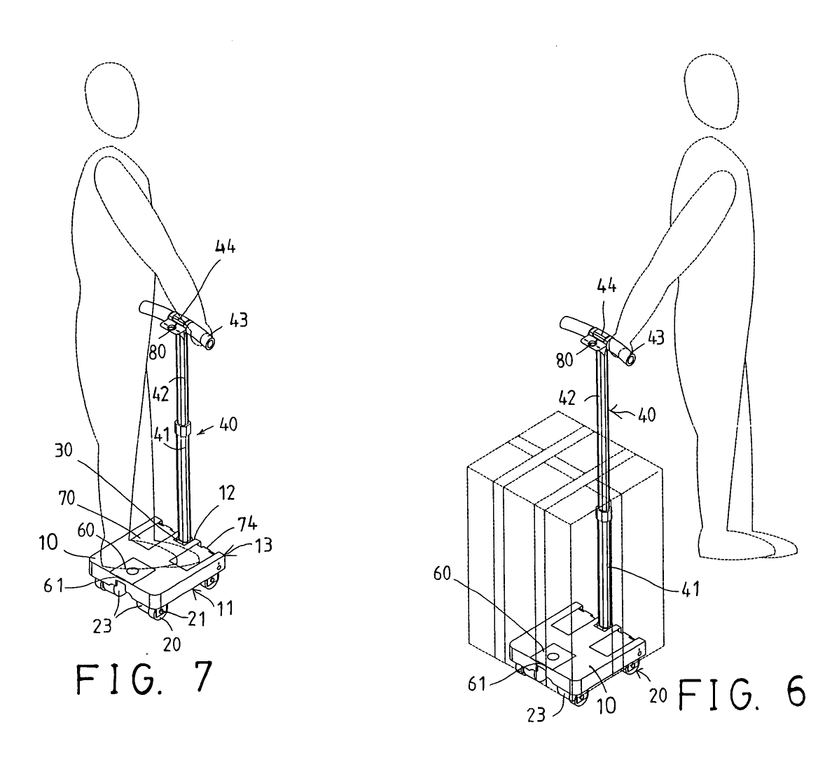

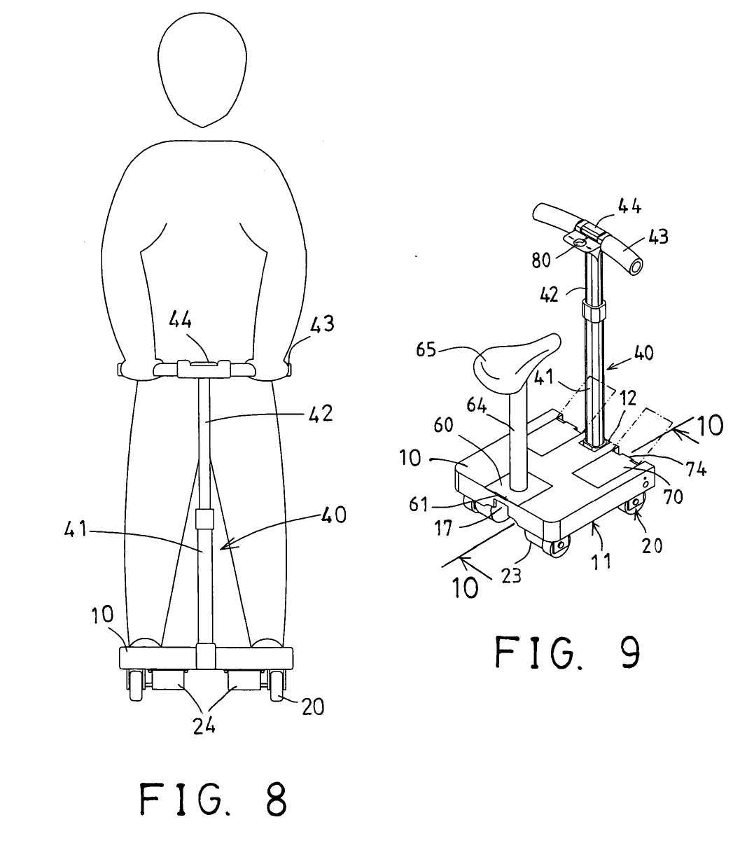

One or more, such as two step motors 23 may further be provided (FIGS. 1, 2) and coupled to two of the wheel axles 21 of the wheels 20 (FIGS. 4, 5), for driving and moving the platform 10 of the article carrying cart. One or more, such as two batteries 24 may further be provided (FIGS. 3-5) and coupled to the step motors 23, to energize and to operate the step motors 23. The step motors 23 and the batteries 24 may thus be used as a moving or driving means or device for moving the platform 10, or for actuating the wheels 20 to move the platform 10. The platform 10 may be used for carrying or supporting the users thereon (FIGS. 7, 8), the luggage articles thereon (FIG. 6), or other articles.

The platform 10 includes an opening 12 formed in the front portion 13 thereof for receiving a barrel 30 therein, and a shaft 14 is secured to the platform 10 and extended through the opening 12 of the platform 10, and engaged through an orifice 31 of the barrel 30, for pivotally or rotatably attaching or securing the barrel 30 to the platform 10. The platform 10 further includes one or more, such as two cavities 15, 16 formed therein (FIGS. 1, 4-5 and 14), and offset from each other.

The barrel 30 includes an aperture 32 formed therein (FIG. 1), and preferably located above the shaft 14 and the orifice 31 thereof. A block 33 is received in the barrel 30, and also includes an orifice 34 formed therein for receiving the shaft 14, and thus for solidly securing the block 33 within the barrel 30. It is preferable that the block 33 includes a channel 35 formed in the upper portion thereof, and opening or facing upwardly, and aligned with the aperture 32 of the barrel 30, for slidably receiving a latch 36.

A handle device 40 includes a tube 41 having a lower portion secured to the barrel 30, such that the handle device 40 may also be rotated relative to the platform 10 together with the barrel 30, about the shaft 14, and includes one or more extensions 42 slidably engaged in the tube 41, and extendible out of the tube 41 to form a retractable or telescopic structure, and includes a hand grip 43 formed or provided on top of the extension 42, for supporting the upper portions of the users.

A knob 44 is slidably engaged in the hand grip 43 and/or in the extension 42 of the handle device 40, and located on top of the extension 42 of the handle device 40, and includes a rod 45 secured thereto and moved in concert with each other (FIGS. 4, 5), and slidably engaged into the extension 42 and/or the tube 41 of the handle device 40. The rod 45 includes a lower end having a block or actuator 46 secured thereto, for actuating the latch 36, which will be discussed hereinafter.

As shown in FIGS. 1 and 4-5, the latch 36 includes a slot 37 formed therein, for slidably receiving a follower 47 therein, and includes a pin 38 engaged into the latch 36, and laterally engaged through the slot 37 of the latch 36. The follower 47 includes an inclined groove 48 formed therein, to slidably receive the pin 38, and includes an enlarged head 49 provided and formed on top thereof, for slidably engaging in the tube 41, and for limiting the follower 47 to slide up and down relative to the tube 41, and for preventing the follower 47 from moving sidewise or laterally relative to the tube 41.

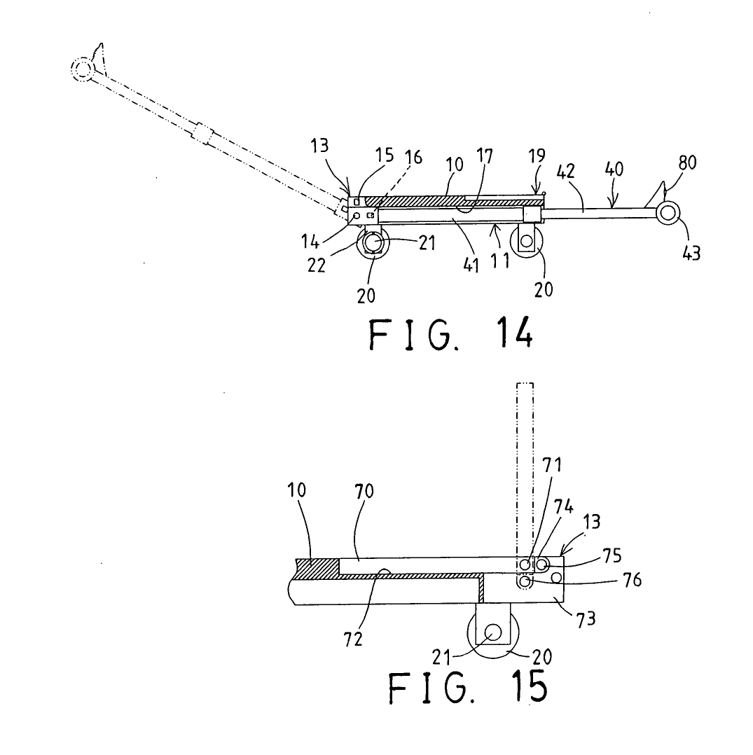

A spring member 50 may further be provided and engaged with the follower 47, for biasing or moving the follower 47 upwardly away from the block 33 and the barrel 30. The inclined groove 48 of the follower 47 is arranged to force the latch 36 to move out of the block 33, or to engage into either of the cavities 15, 16 of the platform 10 (FIG. 4), in order to latch or to lock the handle device 40 to the platform 10 at either an upwardly extended working position (FIGS. 2 and 4-9), or a folding position (FIG. 14), when the follower 47 is biased or moved upwardly away from the block 33 and the barrel 30.

On the contrary, when he follower 47 is forced or moved downwardly toward the block 33 and the barrel 30, as shown in FIG. 5, by such as the actuator 46 of the rod 45, the inclined groove 48 of the follower 47 is arranged to force the latch 36 to move inwardly or into the block 33, and to be disengaged from the cavities 15, 16 of the platform 10, in order to release the handle device 40, and thus to allow the handle device 40 to be rotated relative to the platform 10 about the shaft 14. The latch 36 may thus be used as a latching means or device to selectively latch and position the handle device 40 on the platform 10 at the upwardly extended working position (FIGS. 2 and 4-9).

As shown in FIG. 14, the platform 10 includes a recess 17 formed in the bottom portion 11: thereof, to selectively receive the handle device 40, and to allow the handle device 40 to be rotated relative to the platform 10 and to be engaged in the recess 17 of the platform 10 in the folding position (FIGS. 12-14). At this moment, the latch 36 may be engaged into the cavity 16 of the platform 10, to latch or to lock the handle device 40 to the platform 10 at the folding position, and to prevent the handle device 40 from being rotated out of the recess 17 of the platform 10.

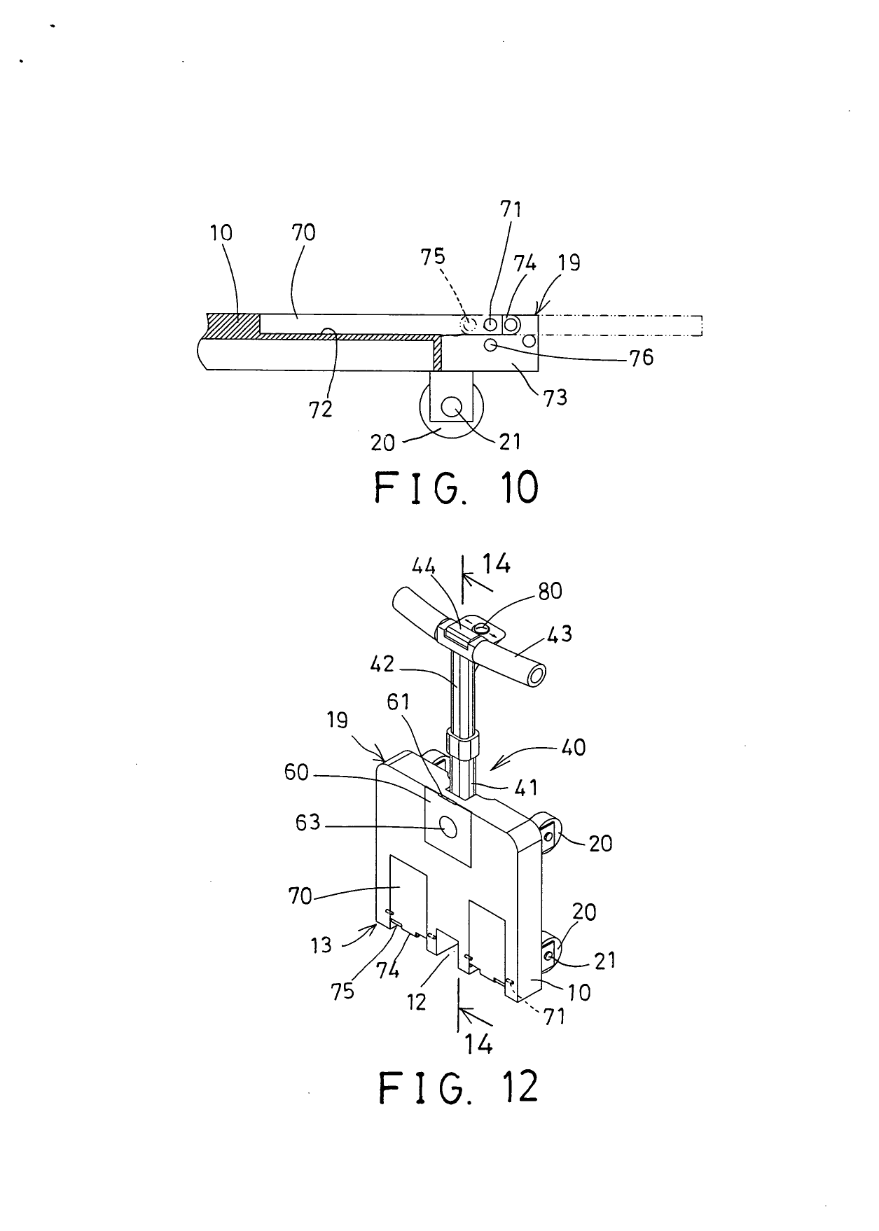

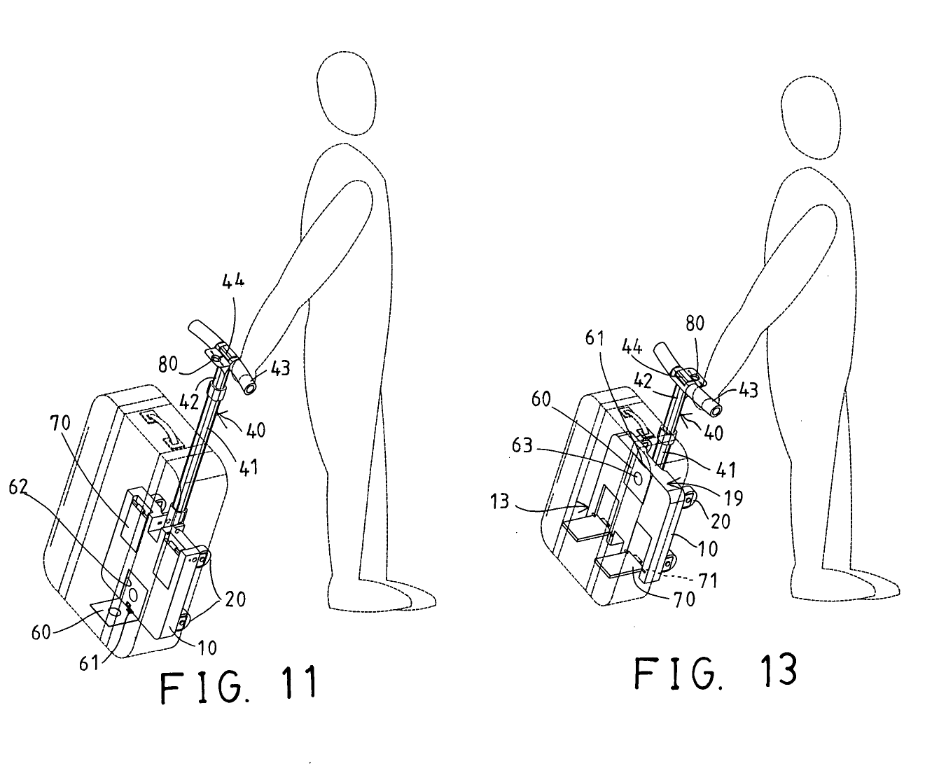

As shown in FIGS. 1-3, 6-7, 9 and 11-13, a flap 60 is pivotally or foldably secured to the rear portion 19 of the platform 10 with such as a pivot joint 61 which is arranged to allow the flap 60 to be rotated relative to the platform 10 between an upwardly extended working position (FIG. 11), or a downwardly folding position (FIGS. 6-7 and 9). It is preferable that the platform 10 includes a depression 62 formed in the upper portion thereof (FIG. 11), to selectively receive the flap 60 within the downwardly folding position.

In operation, as shown in FIG. 11, when the flap 60 is rotated relative to the platform 10 to the upwardly extended working position, the flap 60 may be used to position or to anchor or to attach the articles disposed or carried on the platform 10. The flap 60 may further include a hole 63 formed therein (FIGS. 1, 2), for selectively attaching or securing or engaging with a seat post 64 to the flap 60 (FIG. 9). A seat cushion 65 may further be provided and attached onto the seat post 64, to support the users thereon.

The platform 10 further includes one or more, such as two foot pedals 70 pivotally or rotatably attached to the front portion 13 thereof with pivot poles 71 (FIG. 1), and preferably includes one or more, such as two depressions 72 formed therein to selectively and to safely receive the foot pedals 70 therein, and a notch 73 formed therein and communicating with each of the depressions 72 thereof, to rotatably receiving a stud 74 which is extended from the foot pedals 70.

For example, as shown in FIGS. 10 and 15, the studs 74 of the foot pedals 70 are rotatably received within the notches 73 of the platform 10 respectively, to allow the foot pedals 70 to be rotated relative to the platform 10 about the pivot poles 71, between an inwardly receiving position (FIGS. 2, 11-12) and an outwardly extending or opening or working position as shown in dotted lines in FIG. 10. A spring-biased catch 75 may be engaged in the stud 74 of each of the foot pedals 70, to latch or to anchor the foot pedals 70 to the platform 10 at the predetermined position.

For example, as shown in FIGS. 10 and 15, the platform 10 may include one or more holes 76 formed therein, to selectively engage with the spring-biased catches 75 of the foot pedals 70, and to latch or to anchor the foot pedals 70 to the platform 10 at some selected positions, such as the inwardly receiving position as shown in solid lines in FIGS. 10 and 15, the outwardly extending or opening or working position as shown in dotted lines in FIG. 10, or the upwardly extending or anchoring position as shown in dotted lines in FIG. 15, or the forwardly and inclinedly extending or supporting position as shown in dotted lines in FIG. 9, for acting as foot pedals to support the feet of the users.

In operation, as shown in FIG. 6, the articles may be directly disposed and supported on the platform 10, for being carried or moved to any places or positions. As shown in FIG. 3, the handle device 40 may also be rotated relative to the platform 10 to a forwardly inclined or towing position, to allow the platform 10 and the articles to be easily carried or moved to any places or positions. As shown in FIG. 11, the flap 60 may be rotated relative to the platform 10 to the upwardly extended working position, to position or to anchor the articles on the platform 10.

As shown in FIGS. 7 and 8, the users may stand on the platform 10, and the step motors 23 may rotate the wheels 20 to drive and to move the platform 10 to any required places or positions. An actuator button 80 may further be provided and disposed on the hand grip 43 and/or the extension 42 of the handle device 40, for operating the step motors 23, and for allowing the users to control or to maneuver or to manipulate the article carrying cart. As shown in FIG. 9, the users may also be seated on the seat cushion 65.

As shown in FIGS. 12-15, the handle device 40 may be rotated relative to the platform 10 and engaged in the recess 17 of the platform 10 in the folding position, to decrease the size or the volume of the article carrying cart, and to facilitate the folding and transportation purposes of the article carrying cart. As shown in FIG. 13, when the foot pedals 70 are rotated relative to the platform 10 to the upwardly extending or anchoring position, the foot pedals 70 may also be used to position or to anchor the articles on the platform 10.

Accordingly, the article carrying cart in accordance with the present invention is changeable to various kinds of structures, for carrying the users, the luggage articles, or other articles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An article carrying cart comprising:
a platform including a wheel device rotatably attached to a bottom portion thereof with a wheel axle, to allow said platform to be moved with said wheels,
a handle device pivotally attached to said platform,
means for latching said handle device on said platform at an upwardly extending and working position, and
means for actuating said wheel device to move said platform.

2. The article carrying cart as claimed in claim 1, wherein said actuating means includes at least one step motor attached to said bottom portion of said platform, and coupled to said wheel axle of said wheel device, to rotate said wheel device.

3. The article carrying cart as claimed in claim 2, wherein said platform includes at least one battery attached to said bottom portion thereof and coupled to said at least one step motor, to energize said at least one step motor.

4. The article carrying cart as claimed in claim 2, wherein said handle device includes an actuator button disposed thereon, for operating said at least one step motor to control said article carrying cart.

5. The article carrying cart as claimed in claim 1, wherein said platform includes a front portion having an opening formed therein, a barrel received in said opening of said platform and rotatably secured to said platform with a shaft, said handle device is secured to said barrel.

6. The article carrying cart as claimed in claim 5, wherein said platform includes a cavity formed therein, said barrel includes an aperture formed therein for selectively aligning with said cavity of said platform, said latching means includes a latch slidably received in said barrel and engaged through said aperture of said barrel, for selectively engaging through said cavity of said platform, to selectively latch and lock said barrel and said handle device to said platform at the upwardly extending and working position.

7. The article carrying cart as claimed in claim 6, wherein said barrel includes a block received therein and having a channel formed therein to slidably receive said latch.

8. The article carrying cart as claimed in claim 7, wherein said latch includes a slot formed therein, a follower is slidably received in said slot of said latch and includes an inclined groove formed therein, a pin is engaged into said latch and engaged through said slot of said latch and engaged through said inclined groove of said follower, to force said latch in and out relative to said barrel when said follower is moved up and down relative to said barrel and said platform.

9. The article carrying cart as claimed in claim 8, wherein said barrel includes a spring member disposed therein and engaged with said follower, for biasing said follower upwardly away from said block, and to force said latch to engage into said cavity of said platform.

10. The article carrying cart as claimed in claim 8, wherein said handle device includes a tube secured to said barrel, and at least one extension slidably engaged in said tube, and extendible out of said tube, said follower includes an enlarged head provided thereon and slidably engaged in said tube, for limiting said follower to slide up and down relative to said tube, and for preventing said follower from moving sidewise or laterally relative to said tube.

11. The article carrying cart as claimed in claim 10, wherein said handle device includes a hand grip provided thereon for supporting an upper portion of a user.

12. The article carrying cart as claimed in claim 10, wherein said handle device includes a knob slidably engaged therein, and a rod secured to said knob and moved in concert with said knob, and slidably engaged into said at least one extension and said tube of said handle device, said rod includes a lower actuator secured thereto, for actuating said follower to move said latch in and out relative to said barrel.

13. The article carrying cart as claimed in claim 1, wherein said platform includes a rear portion having a flap pivotally thereto with a pivot joint, and arranged to be rotated relative to said platform between a downwardly folding position and an upwardly extended working position to selectively anchor articles on said platform.

14. The article carrying cart as claimed in claim 13, wherein said platform includes a depression formed in an upper portion thereof to selectively receive said flap in said downwardly folding position.

15. The article carrying cart as claimed in claim 13, wherein said flap includes a seat post selectively attached and secured thereon, and a seat cushion attached onto said seat post, to support a user thereon.

16. The article carrying cart as claimed in claim 1, wherein said platform includes a front portion having at least one foot pedal pivotally attached thereto with a pivot pole, and includes a stud extended from said at least one foot pedal, and a spring-biased catch engaged in said stud, to engage with said platform, and to anchor said at least one foot pedal to said platform at a selected position.

17. The article carrying cart as claimed in claim 16, wherein said platform includes a depression formed therein to selectively receive said at least one foot pedal therein.

18. The article carrying cart as claimed in claim 17, wherein said platform includes a notch formed therein and communicating with said depression thereof, to rotatably receiving said stud of said at least one foot pedal.

19. The article carrying cart as claimed in claim 1, wherein said platform includes a recess formed in said bottom portion thereof, to selectively receive said handle device in a folding position.
